(19) United States
(12) Patent Application Publication
(10) Pub. No.: US 2024/0020163 A1
(43) Pub. Date: Jan. 18, 2024

(54) SYSTEM AND METHOD FOR AUTOMATICALLY PROVIDING A SECOND RESOURCE TYPE TO REPLACE OR OFFSET A FIRST RESOURCE TYPE

(71) Applicant: The Toronto-Dominion Bank, Toronto (CA)

(72) Inventors: Sara COLLIS, Toronto (CA); Alexander Christian Raphael VENDITTI, Caledon (CA); Dinshaw BHARUCHA, Toronto (CA); David REILLY, Toronto (CA); Goran ILKHANIZADEH, Ottawa (CA)

(73) Assignee: The Toronto-Dominion Bank, Toronto (CA)

(21) Appl. No.: 17/866,630

(22) Filed: Jul. 18, 2022

(51) Int. Cl. G06F 9/50; G06F 11/34

(52) U.S. Cl. CPC G06F 9/5033; G06F 11/3495

(57) ABSTRACT

A computer server system comprises a communications module; a processor coupled with the communications module; and a memory coupled to the processor and storing processor-executable instructions which, when executed by the processor, configure the processor to monitor resource consumption data to identify a first resource type being provided to a resource requester at a periodic rate; identify a second resource type to replace or offset the first resource type at the periodic rate; and perform operations to automatically provide the second resource type to replace or offset the first resource type at the periodic rate.

### TECHNICAL FIELD

The present application relates to systems and methods for automatically providing a second resource type to replace or offset a first resource type.

### BACKGROUND

Resources may be provided to resource requesters. For example, computing resources may be provided to one or more software applications executing on a computer.

Resources may be limited and as such resource management may be difficult.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a table showing example resource consumption data according to an embodiment;

FIG. 6 is a flowchart showing operations performed in automatically providing a second resource type to replace or offset a first resource type according to an embodiment; and

FIG. 7 is a flowchart showing operations performed in providing a recommendation for providing a second resource type to replace or offset a first resource type according to an embodiment;

FIG. 8 is an example interface displayed on a display screen of a computing device according to an embodiment; and

FIG. 9 is a flowchart showing operations performed in providing a recommendation for cancelling a service provided by the resource requester.

Like reference numerals are used in the drawings to denote like elements and features.

### DETAILED DESCRIPTION OF VARIOUS EMBODIMENTS

Accordingly, in one aspect there is provided a computer server system comprising a communications module; a processor coupled with the communications module; and a memory coupled to the processor and storing processor-executable instructions which, when executed by the processor, configure the processor to monitor resource consumption data to identify a first resource type being provided to a resource requester at a periodic rate; identify a second resource type to replace or offset the first resource type at the periodic rate; and perform operations to automatically provide the second resource type to replace or offset the first resource type at the periodic rate.

In one or more embodiments, the processor-executable instructions, when executed by the processor, further configure the processor to determine an amount of the first resource type provided to the resource requester at the periodic rate; and provide an amount of the second resource type to replace or offset the first resource type at the periodic rate based on the amount of the first resource type provided to the resource requester at the periodic rate.

In one or more embodiments, the amount of the second resource type provided to replace or offset the first resource type at the periodic rate is determined based on a modifier between the first resource type and the second resource type.

In one or more embodiments, the second resource type is provided to replace the first resource type at the periodic rate and the processor-executable instructions, when executed by the processor, further configure the processor to automatically provide the second resource type to the resource requester to replace the first resource type at the periodic rate.

In one or more embodiments, the second resource type is provided to offset the first resource type at the periodic rate and the processor-executable instructions, when executed by the processor, further configure the processor to automatically provide the second resource type to a resource account associated with the first resource type at the periodic rate to offset the first resource type.

In one or more embodiments, the processor-executable instructions, when executed by the processor, further configure the processor to obtain, via the communications module, usage data; analyze the usage data to determine that a service provided by the resource requester is not being used; and responsive to determining that the service provided by the resource requester is not being used, send, via the communications module and to a computing device, a signal causing the computing device to display a user interface that includes a recommendation for cancelling the service provided by the resource requester and a selectable interface element for accepting the recommendation.

In one or more embodiments, the processor-executable instructions, when executed by the processor, further configure the processor to receive, via the communications module and from the computing device, a signal indicating selection of the selectable interface element for accepting the recommendation; and send, via the communications module and to a third party server associated with the resource requester, a signal requesting cancellation of the service provided by the resource requester.

In one or more embodiments, the usage data includes at least one of network data obtained from a third party server associated with the resource requester or location data obtained from the computing device.

In one or more embodiments, the processor-executable instructions, when executed by the processor, further configure the processor to send, via the communications module and to a computing device, a signal causing the computing device to display a user interface that includes a recommendation for providing the second resource type to replace or offset the first resource type at the periodic rate and a selectable interface element for accepting the recommendation; and receive, via the communications module and from the computing device, a signal indicating selection of the selectable interface element for accepting the recommendation.

In one or more embodiments, the first resource type is provided from a first resource account and the second resource type is provided from a second resource account.

According to another aspect there is provided a computer-implemented method comprising monitoring resource consumption data to identify a first resource type being provided to a resource requester at a periodic rate; identifying a second resource type to replace or offset the first resource type at the periodic rate; and performing operations to automatically provide the second resource type to replace or offset the first resource type at the periodic rate.

In one or more embodiments, the method further comprises determining an amount of the first resource type provided to the resource requester at the periodic rate; and providing an amount of the second resource type to replace or offset the first resource type at the periodic rate based on the amount of the first resource type provided to the resource requester at the periodic rate.

In one or more embodiments, the amount of the second resource type provided to replace or offset the first resource type at the periodic rate is determined based on a modifier between the first resource type and the second resource type.

In one or more embodiments, the second resource type is provided to replace the first resource type at the periodic rate and the method further comprises automatically providing the second resource type to the resource requester to replace the first resource type at the periodic rate.

In one or more embodiments, the second resource type is provided to offset the first resource type at the periodic rate and the method further comprises automatically providing the second resource type to a resource account associated with the first resource type at the periodic rate to offset the first resource type.

In one or more embodiments, the method further comprises obtaining, via a communications module, usage data; analyzing the usage data to determine that a service provided by the resource requester is not being used; and responsive to determining that the service provided by the resource requester is not being used, sending, via the communications module and to a computing device, a signal causing the computing device to display a user interface that includes a recommendation for cancelling the service provided by the resource requester and a selectable interface element for accepting the recommendation.

In one or more embodiments, the method further comprises receiving, via the communications module and from the computing device, a signal indicating selection of the selectable interface element for accepting the recommendation; and sending, via the communications module and to a third party server associated with the resource requester, a signal requesting cancellation of the service provided by the resource requester.

In one or more embodiments, the usage data includes at least one of network data obtained from a third party server associated with the resource requester or location data obtained from the computing device.

In one or more embodiments, the method further comprises sending, via a communications module and to a computing device, a signal causing the computing device to display a user interface that includes a recommendation for providing the second resource type to replace or offset the first resource type at the periodic rate and a selectable interface element for accepting the recommendation; and receiving, via the communications module and from the computing device, a signal indicating selection of the selectable interface element for accepting the recommendation.

According to another aspect there is provided a non-transitory computer readable storage medium comprising computer-executable instructions which, when executed, configure a processor to monitor resource consumption data to identify a first resource type being provided to a resource requester at a periodic rate; identify a second resource type to replace or offset the first resource type at the periodic rate; and perform operations to automatically provide the second resource type to replace or offset the first resource type at the periodic rate.

In manners described herein, a second resource type is identified and automatically provided to replace or offset a first resource type being provided at a periodic rate. Conveniently, and in this way, resource consumption data may be utilized to manage or schedule the consumption of computing resources. For example, a particular application may request the use of physical memory at a periodic rate. Once identified, a secondary or external type of memory may be used to replace or offset the use of the physical memory at the periodic rate and this may free up physical memory for applications that unexpectedly or randomly require the use of physical memory.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

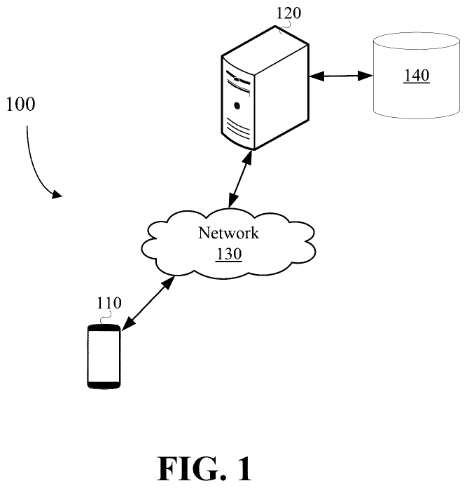

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may be a smartphone as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The computing device 110 may be adapted to receive, from the server computer system 120, a signal that causes the computing device 110 to display an interface that allows for communication with the server computer system 120.

The server computer system 120 may be associated with or may communicate with a database 140 that stores data records. The data records may store resource consumption data that includes a list of resource requesters and an amount of resources provided to the resource requesters. The data records may be updated or maintained by the server computer system 120 and this may be done each time resources are provided to a resource requester. The resource consumption data may be stored in the database 140 in association with a resource account.

The resources provided to the resource requesters may be of different types. For example, a resource requester may request a first resource type and/or a second resource type. As another example, a resource requester may request a first resource type but may accept a first resource type or a second resource type. As another example, a resource requester may only accept a first resource type. In this example, responsive to the first resource type being provided to the resource requester from a resource account, a second resource type may be provided to the resource account. As will be described in more detail below, the second resource type may be automatically provided to replace or offset the first resource type.

The server computer system 120 may communicate with the database 140 directly or through the network 130. The server computer system 120 may communicate with one or more third party servers through the network 130 and the one or more third party servers may be associated with resource requesters and/or resource collectors.

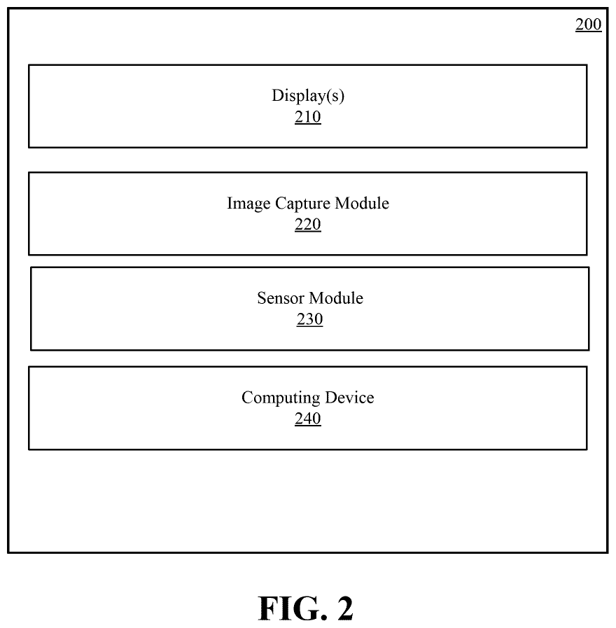

FIG. 2 is a simplified schematic diagram showing components of an exemplary computing device 200. The computing device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

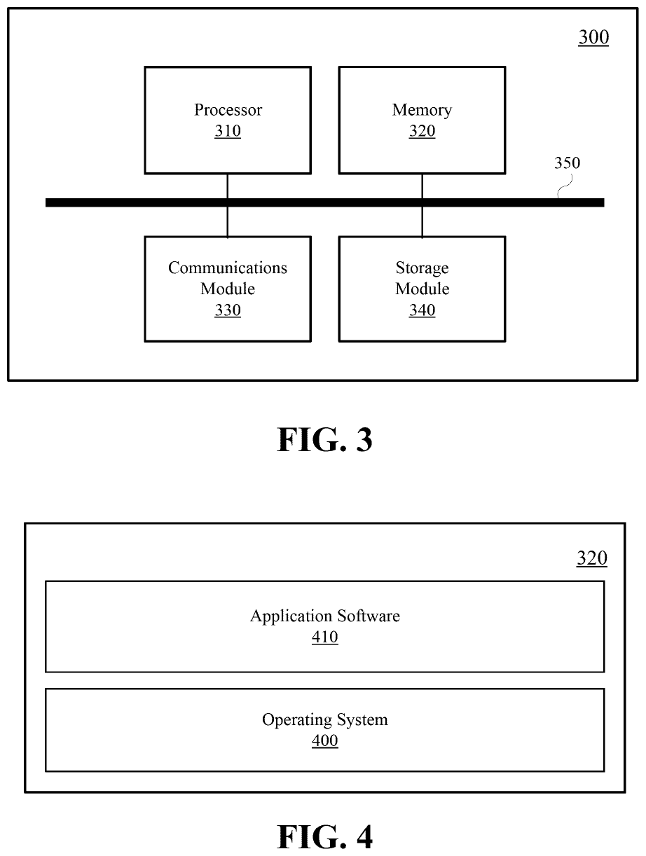

Referring now to FIG. 3, a high-level operation diagram of an example computer device 300 is shown. In some embodiments, the computer device 300 may be exemplary of the computer device 240 (FIG. 2) and/or server computer system 120.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2) and/or the server computer system 120.

While a single application 410 is illustrated in FIG. 3, in operation the memory 320 may include more than one application 410 and different applications 410 may perform different operations. For example, in at least some embodiments in which the computer device 300 is functioning as the computing device 110, the applications 410 may include a resource management application.

The resource management application may be configured to present one or more graphical user interfaces on a display of the computing device 110 and may provide various resource management functions. The resource management functions may include monitoring resource consumption data. For example, the resource management application may monitor resource consumption data to identify a first resource type being provided to a resource requester at a periodic rate. As will be described in more detail below, a second resource type may be identified and may be automatically provided to replace or offset the first resource type at the periodic rate.

It will be appreciated that the resource management application may require authentication credentials such as for example a username and a password prior to providing access thereto. In one or more embodiments, within the resource management application, one or more resource accounts may be linked to the resource management application. For example, the resource management application may provide a user interface that include one or more selectable interface elements for linking one or more resource accounts thereto.

The computing device 110 and/or the server computer system 120 may monitor resource consumption data that includes a list of resource requesters and an amount of resources provided to the resource requesters. For example, the computing device 110 may identify a list of applications executing thereon and may determine the amount of computing resources being consumed by the applications. In this example, the computing resources may include a number of different resource types such as for example total processor utilization, disk utilization, network utilization, power usage, random access memory (RAM) utilization, and virtual memory utilization. In one or more embodiments, the resource consumption data may be obtained from a computing resource application executing on the computing device 110.

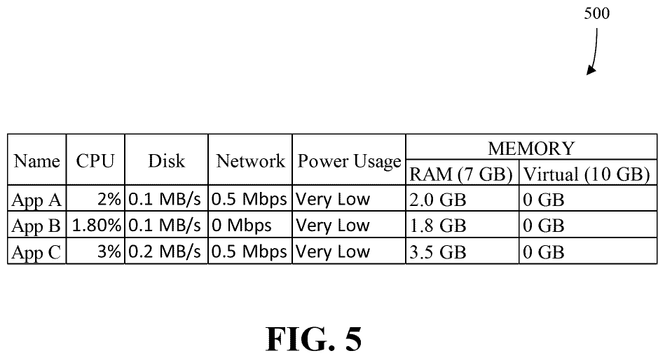

An example table 500 that includes resource consumption data is shown in FIG. 5. In this example, the resource requesters include applications executing on the computing device 110. As such, the table 500 includes a list of applications (“App A”, “App B”, “App C”) and resource consumption data identifying an amount of computing resources being consumed by or provided to each application.

The resource consumption data may be obtained in real-time and as such the amount of computing resources being consumed by each application may include a current amount of computing resources being consumed. The computing device 110 may store the resource consumption data in memory and/or may communicate the resource consumption data to the server computer system 120 where it may be stored in the database 140. The resource consumption data may be monitored or analyzed by the computing device 110 and/or the server computer system 120. For example, the computing device 110 and/or the server computer system 120 may calculate or determine an average amount of resources being consumed by application and the resource consumption data may include the average amount of resources being consumed by each application.

In one or more embodiments, the resource consumption data may be associated with a particular resource type. For example, the particular resource type may include network bandwidth. As such, the computing device 110 and/or the server computer system 120 may generate the resource consumption data to include a list of resource requesters and an amount of network bandwidth consumed by or provided to each application.

In one or more embodiments, the resource consumption data may be associated with two resource types that may be related. For example, a first resource type may include random access memory (RAM) and a second resource type may include virtual memory. In this example, the second resource type may be used as a substitute or replacement for the first resource type and this may be done in an effort to replace or offset the amount of the first resource type being used.

As another example of two resource types that may be related, an amount of a first resource type may be provided from a first resource account to a resource requester. The amount of the first resource type provided to the resource requester may be based on, for example, a transaction conducted between the resource requester and a user associated with the resource account. An amount of a second resource type may be provided to replace or offset the first resource type. The second resource type may be provided from a second resource account. For example, an amount of the second resource type from the second resource account may be used to replace or offset an amount of the first resource type provided from the first resource account to the resource requester. In this example, the first resource type may be related to the second resource type in that a modifier may be used to determine the amount of the second resource type to be provided based on the amount of the first resource type provided.

The server computer system 120 and/or the computing device 110 may monitor resource consumption data and may perform operations to automatically provide a second resource type to replace or offset a first resource type.

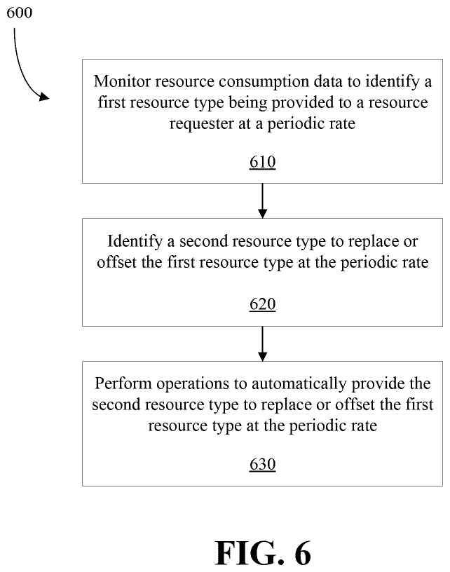

Reference is made to FIG. 6, which illustrates, in flowchart form, a method 600 for automatically providing a second resource to replace or offset a first resource type. The method 600 may be implemented by a computing device having suitable processor-executable instructions for causing the computing device to carry out the described operations. The method 600 may be implemented, in whole or in part, by the server computer system 120 and/or the computing device 110.

The method 600 includes monitoring resource consumption data to identify a first resource type being provided to a resource requester at a periodic rate (step 610).

The resource consumption data is monitored to identify a first resource type being provided to a resource requester at a periodic rate. In this embodiment, the resource consumption data includes historical resource consumption data that may be retrieved from the database 140.

Specifically, the server computer system 120 may analyze the resource consumption data to identify a first resource type that is provided to a particular resource requester at a periodic rate. The rate may be based on processor cycles, time, date, etc. For example, a first resource type may be identified as being provided to a particular resource requester at a periodic rate when it is determined that the first resource type is provided every processor cycle to the particular resource requester. As another example, a first resource type may be identified as being provided to a particular resource requester at a periodic rate when it is determined that the first resource type is provided every hour or every month to the particular resource requester.

In one or more embodiments, the first resource type may only be identified as being provided to the particular resource requester at the periodic rate in the event that that the first resource type is provided at the periodic rate for a threshold number of periods. For example, the threshold number of periods may include six (6) processor cycles and as such the first resource type may be identified as being provided to the particular resource requester at the periodic rate only when it is determined that the first resource type has been provided to the particular resource requester over the past six (6) processor cycles. As another example, the threshold number of periods may include three (3) months and as such the first resource type may be identified as being provided to the particular resource requester at the periodic rate when it is determined that the first resource type has been provided to the particular resource requester once a month for the past three (3) months.

In one or more embodiments, the first resource type may only be identified as being provided to the particular resource requester at the periodic rate in the event that a threshold amount of the first resource type is provided at the periodic rate for a threshold number of periods. For example, a first resource type may include RAM and may include a threshold amount of one (1) GB. As such, the first resource type may only be identified as being provided to the particular resource requester at the periodic rate when more than one (1) GB has been provided to the particular resource requester over the last six (6) processor cycles.

In one or more embodiments, the first resource type may only be identified as being provided to the particular resource requester at the periodic rate in the event that a particular or same amount of the first resource type is provided at the periodic rate for a threshold number of periods. For example, a first resource type may include an amount of the first resource type provided to the particular resource requester at a periodic rate of once per month for the last three (3) months. The amount may be, for example, a dollar amount such as for example ten dollars ($10). As such, the first resource type may only be identified as being provided to the particular resource requester at the periodic rate when the same amount of the first resource type has been provided to the particular resource requester over the last three (3) months.

The method 600 includes identifying a second resource type to replace or offset the first resource type at the periodic rate (step 620).

In one or more embodiments, the second resource type that is identified to replace or offset the first resource type at the periodic rate may be identified as a resource type that is related to the first resource type.

As an example, the first resource type may include memory and as such the server computer system 120 and/or the computing device 110 may identify a second resource type that is related to the first resource type in that the second resource type also includes memory. For example, the first resource type may include RAM and the second resource type may include virtual memory.

As another example, the first resource type may include an amount of a first resource type provided to the resource requester and as such the server computer system 120 and/or the computing device 110 may identify a second resource type to replace or offset the first resource type as being an amount of a second resource type. The first resource type may be provided from a first resource account and the second resource type may be provided from a second resource account.

An amount of the first resource type may be determined and an amount of the second resource type to replace or offset the first resource type at the periodic rate may be based on the amount of the first resource type provided to the resource requester at the periodic rate.

As an example, the first resource type and the second resource type may be directly related in that no modifier is required to replace or offset the first resource type at the periodic rate. For example, in embodiments where the first resource type and the second resource type include memory, an amount of the first resource type (RAM) provided to the resource requester at the periodic rate may be equal to an amount of the second resource type (virtual memory) to be provided to the resource requester to replace or offset the RAM provided to the resource requester at the periodic rate. As a specific example, the amount of RAM provided to the resource requester at the periodic rate may include 1 GB and as such the amount of virtual memory to be provided to the resource requester to replace or offset the RAM at the periodic rate is 1 GB.

As another example, a modifier may be required to replace or offset the first resource type at the periodic rate. For example, a modifier may be used to convert the second resource type to the first resource type. As a specific example, an amount of the first resource type provided to the resource requester at the periodic rate may be ten dollars ($10). A modifier of ten (10) loyalty points to dollars may be required to convert a second resource type (loyalty points) to the first resource type (dollar amount). As such, an amount of the second resource type required to replace or offset the first resource type at the periodic rate may be one hundred (100) loyalty points.

In one or more embodiments, the second resource type may only be identified to replace or offset the first resource type at the periodic rate when it is determined that a threshold amount of the second resource type is available to replace or offset the first resource type at the periodic rate. The threshold may be dependent on whether or not the second resource type is to replace or offset the first resource type.

As an example, one (1) GB of RAM may be provided to the resource requester at the periodic rate and as such to replace the first resource type using the second resource type it is required that a threshold amount of one (1) GB of virtual memory is available at the periodic rate. As another example, one (1) GB of RAM may be provided to the resource requester at the periodic rate and as such to offset the first resource type using the second resource type it may be required that a threshold amount of zero point five (0.5) GB of virtual memory is available at the periodic rate. In this example, zero point five (0.5) GB of RAM and zero point five (0.5) GB of virtual memory may be provided to the resource requester at the periodic rate and in this manner the virtual memory is used to offset the amount of the first resource type provided at the periodic rate.

As another example, an amount of the first resource type provided to the resource requester at the periodic rate may include ten dollars ($10), a modifier may include ten (10) loyalty points to dollars, and as such the threshold amount of loyalty points required to replace the ten dollars ($10) may be one hundred (100) loyalty points. In this example, one hundred (100) loyalty points are required from the second resource account to replace the ten dollars ($10) provided from the first resource account to replace the first resource type provided at the periodic rate. As another example, the threshold amount of loyalty points required to offset the ten ($10) dollars may be fifty (50) loyalty points. In this example, five dollars ($5) may be provided to the resource requester from the first resource account and fifty (50) loyalty points may be provided to the resource requester from the second resource account to offset the amount of dollars provided to the resource requester at the periodic rate.

The method 600 includes performing operations to automatically provide the second resource type to replace or offset the first resource type at the periodic rate (step 630).

The server computer system 120 and/or the computing device 110 perform operations to automatically provide the second resource type to replace or offset the first resource type at the periodic rate. The operations may include sending one or more signals that cause a processor of the computing device or a processor of a third party server to perform operations to automatically provide the second resource type to replace or offset the first resource type at the periodic rate.

In one or more embodiments, the second resource type may be provided to the resource requester at the periodic rate to replace or offset the first resource type. For example, one (1) GB of virtual memory may be provided to the resource requester to replace one (1) GB of RAM and this may be done at the periodic rate, such as for example every six (6) processor cycles. As another example, one hundred (100) loyalty points may be provided to the resource requester to replace ten dollars ($10) and this may be done at the periodic rate, such as for example every one (1) month.

In one or more embodiments, the second resource type may be provided to a first resource account providing the first resource type at the periodic rate to replace or offset the first resource type. For example, ten dollars ($10) may be provided from the first resource account to the resource requester at the periodic rate and as such one hundred (100) loyalty points may be provided from the second resource account to the first resource account at the periodic rate to replace or offset the first resource type at the periodic rate. In this example, the second resource type may be converted to the first resource type using the modifier and this may be done when providing the second resource type to the first resource account.

In one or more embodiments, prior to automatically providing the second resource type to replace or offset the first resource type at the periodic rate, the server computer system 120 and/or computing device 110 may perform operations to provide a recommendation for providing the second resource type to replace or offset the first resource type at the periodic rate.

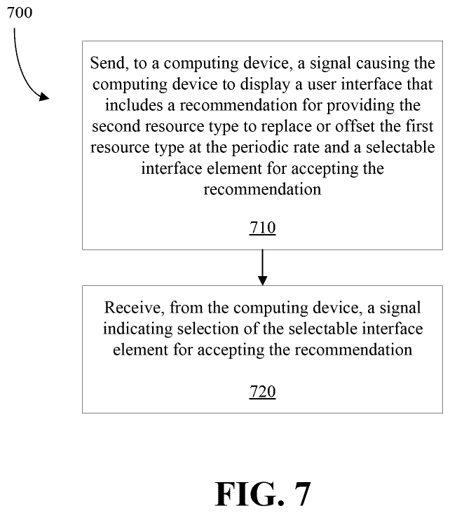

Reference is made to FIG. 7, which illustrates, in flowchart form, a method 700 for providing a recommendation for providing the second resource type to replace or offset the first resource type at the periodic rate. The method 700 may be implemented by a computing device having suitable processor-executable instructions for causing the computing device to carry out the described operations. The method 700 may be implemented, in whole or in part, by the server computer system 120 and/or the computing device 110. The method 700 may be performed responsive to identifying the second resource type to replace or offset the first resource type at the periodic rate as described herein with reference to step 620 of method 600.

The method 700 includes sending, to a computing device, a signal causing the computing device to display a user interface that includes a recommendation for providing the second resource type to replace or offset the first resource type at the periodic rate and a selectable interface element for accepting the recommendation (step 710).

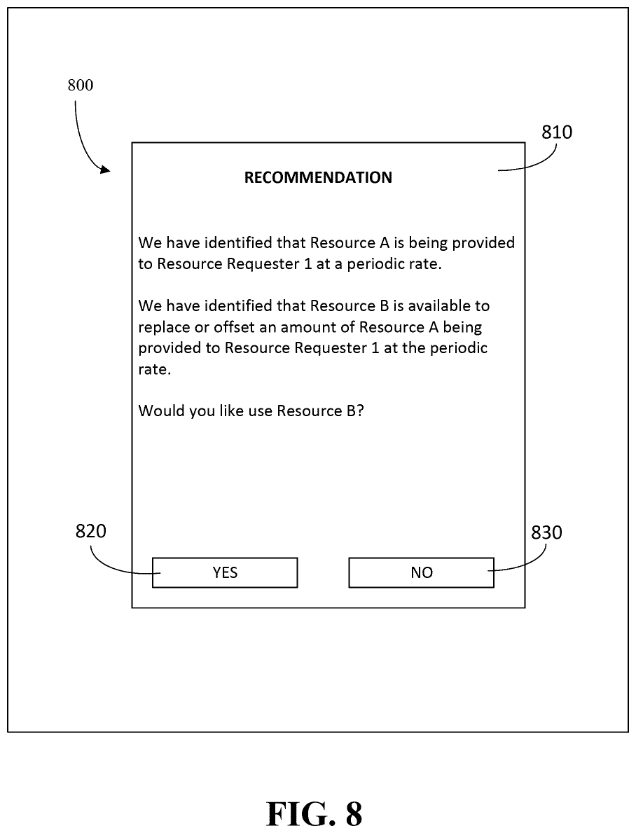

An example user interface 800 is shown in FIG. 8. As can be seen, the user interface includes a recommendation 810 for providing the second resource type to replace or offset the first resource type at the periodic rate. The user interface 800 includes a selectable interface element 820 for accepting the recommendation and a selectable interface element 830 for rejecting the recommendation.

The method 700 includes receiving, from the computing device, a signal indicating selection of the selectable interface element for accepting the recommendation (step 720).

The recommendation may be accepted by performing, for example, a tap gesture on a display screen of the computing device 110 at a location corresponding to the location of the selectable interface element 820. Responsive to selection of the selectable interface element 820, the computing device 110 sends the signal indicating selection of the selectable interface element for accepting the recommendation. In response, the server computer system 120 and/or the computing device 110 may perform operations to automatically provide the second resource type to replace or offset the first resource type at the periodic rate in manners similar to step 630 described herein with reference to the method 600.

It will be appreciated that the second resource type may be automatically provided to replace or offset the first resource type at the periodic rate for a threshold number of periods. In one or more embodiments, the threshold number of periods may be the next one thousand (1000) periods. For example, the periodic rate may be every six (6) processor cycles and as such the second resource type may be automatically provided to replace or offset the first resource type every six (6) processor cycles for the next six thousand (6000) processor cycles. As another example, the threshold number of periods may be the next twelve (12) periods. For example, the periodic rate may be every month and as such the second resource type may be automatically provided to replace or offset the first resource type every month for the next twelve (12) months.

It will be appreciated that the second resource type may be automatically provided to replace or offset the first resource type at the periodic rate until a request to cancel has been received. For example, the periodic rate may be every six (6) processor cycles and as such the second resource type may be automatically provided to replace or offset the first resource type every six (6) processor cycles until a request to cancel has been received. As another example, the periodic rate may be every month and as such the second resource type may be automatically provided to replace or offset the first resource type every month until a request to cancel has been received.

In one or more embodiments, the resource requester may provide a service and as such usage data may be monitored to generate a recommendation to cancel the service provided by the resource requester. The service may include a computer resource management service or membership or subscription based services such as for example streaming services, food delivery services, ride sharing services, music services, gym services, grocery delivery services, etc.

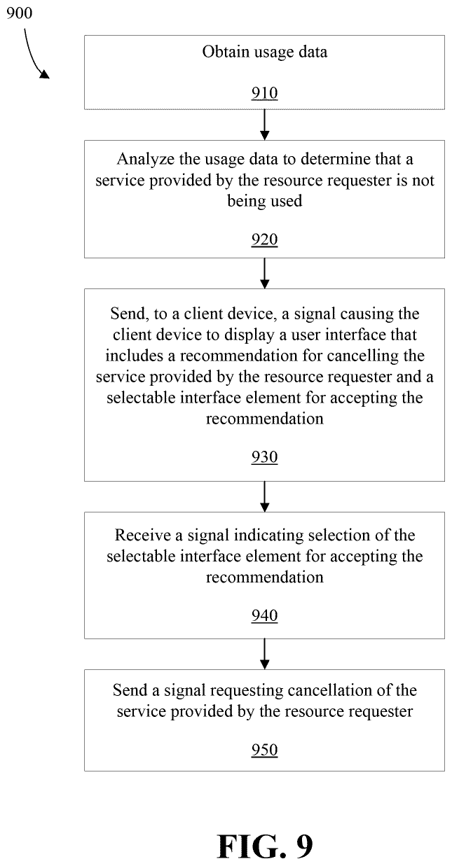

Reference is made to FIG. 9, which illustrates, in flowchart form, a method 700 for providing a recommendation for cancelling a service provided by the resource requester. The method 900 may be implemented by a computing device having suitable processor-executable instructions for causing the computing device to carry out the described operations. The method 900 may be implemented, in whole or in part, by the server computer system 120 and/or the computing device 110.

The method 900 includes obtaining usage data (step 910).

In one or more embodiments, the usage data may be obtained from a third party server associated with the resource requester. For example, the usage data may include, for example, network data, login attempts, etc.

In one or more embodiments, the usage data may be obtained from the computing device 110. For example, the usage data may include location data that indicates a location of the computing device 110.

The method 900 includes analyzing the usage data to determine that a service provided by the resource requester is not being used (step 920).

The usage data may be analyzed to determine that the service provided by the resource requester is not being used. For example, the network data may be analyzed to determine that the service has not been used within the last period and as such it may be determined that the service is not being used. As another example, the location data may be analyzed to determine that the computing device 110 and thus the use has not been within proximity of a physical location of the service within the last period and as such it may be determined that the service is not being used.

The method 900 includes responsive to determining that the service provided by the resource requester is not being used, send, to a computing device, a signal causing the computing device to display a user interface that includes a recommendation for cancelling the service provided by the resource requester and a selectable interface element for accepting the recommendation (step 930).

The user interface may be similar to the user interface 800 described herein, with the exception that the recommendation is the recommendation for cancelling the service provided by the resource requester and the selectable interface elements are for accepting or rejecting the recommendation.

The method 900 includes receiving, from the computing device, a signal indicating selection of the selectable interface element for accepting the recommendation (step 940).

The recommendation may be accepted by performing, for example, a tap gesture on a display screen of the computing device 110 at a location corresponding to the location of the selectable interface element for accepting the recommendation. Responsive to selection of the selectable interface element, the computing device 110 sends the signal indicating selection of the selectable interface element for accepting the recommendation.

The method 900 includes sending, to a third party server associated with the resource requester, a signal requesting cancellation of the service provided by the resource requester (step 950).

Responsive to receiving the signal indicating selection of the selectable interface element for accepting the recommendation, the server computer system 120 and/or the computing device 110 may perform operations to cancel the service provided by the resource requester. The operations may include sending a signal to a third party server associated with the resource requester requesting cancellation of the service. The request may include, for example, an identifier associated with an account maintained by the third party server for the service.

As mentioned, the resource management application may be configured to present one or more graphical user interfaces on a display of the computing device 110 and may provide various resource management functions. Other example resource management functions may include reviewing a list of resource requesters that are currently receiving the second resource type at the periodic rate.

In manners described herein, the server computer system 120 and/or the computing device 110 may utilize the resource consumption data to manage or schedule the consumption of computing resources. For example, the server computer system 120 and/or computing device 110 may replace physical memory (such as RAM) being used periodically by a particular application with a secondary or external type of memory (such virtual memory) and this may free up physical memory for applications that unexpectedly or randomly require memory. Put another way, by identifying applications or other computer processes that periodically require the use of memory, the server computer system 120 and/or computing device 110 may schedule the use of external memory and this may free up the physical memory for the applications or computer processes that randomly or unexpectedly require memory.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer server system comprising:
a communications module;
a processor coupled with the communications module; and
a memory coupled to the processor and storing processor-executable instructions which, when executed by the processor, configure the processor to:
monitor resource consumption data to identify a first resource type being provided to a resource requester at a periodic rate;
identify a second resource type to replace or offset the first resource type at the periodic rate; and
perform operations to automatically provide the second resource type to replace or offset the first resource type at the periodic rate.

2. The computer server system of claim 1, wherein the processor-executable instructions, when executed by the processor, further configure the processor to:
determine an amount of the first resource type provided to the resource requester at the periodic rate; and
provide an amount of the second resource type to replace or offset the first resource type at the periodic rate based on the amount of the first resource type provided to the resource requester at the periodic rate.

3. The computer server system of claim 2, wherein the amount of the second resource type provided to replace or offset the first resource type at the periodic rate is determined based on a modifier between the first resource type and the second resource type.

4. The computer server system of claim 1 wherein the second resource type is provided to replace the first resource type at the periodic rate and the processor-executable instructions, when executed by the processor, further configure the processor to:
automatically provide the second resource type to the resource requester to replace the first resource type at the periodic rate.

5. The computer server system of claim 1 wherein the second resource type is provided to offset the first resource type at the periodic rate and the processor-executable instructions, when executed by the processor, further configure the processor to:
automatically provide the second resource type to a resource account associated with the first resource type at the periodic rate to offset the first resource type.

6. The computer server system of claim 1, wherein the processor-executable instructions, when executed by the processor, further configure the processor to:
obtain, via the communications module, usage data;
analyze the usage data to determine that a service provided by the resource requester is not being used; and
responsive to determining that the service provided by the resource requester is not being used, send, via the communications module and to a computing device, a signal causing the computing device to display a user interface that includes a recommendation for cancelling the service provided by the resource requester and a selectable interface element for accepting the recommendation.

7. The computer server system of claim 6, wherein the processor-executable instructions, when executed by the processor, further configure the processor to:
receive, via the communications module and from the computing device, a signal indicating selection of the selectable interface element for accepting the recommendation; and
send, via the communications module and to a third party server associated with the resource requester, a signal requesting cancellation of the service provided by the resource requester.

8. The computer server system of claim 6, wherein the usage data includes at least one of network data obtained from a third party server associated with the resource requester or location data obtained from the computing device.

9. The computer server system of claim 1, wherein the processor-executable instructions, when executed by the processor, further configure the processor to:
send, via the communications module and to a computing device, a signal causing the computing device to display a user interface that includes a recommendation for providing the second resource type to replace or offset the first resource type at the periodic rate and a selectable interface element for accepting the recommendation; and
receive, via the communications module and from the computing device, a signal indicating selection of the selectable interface element for accepting the recommendation.

10. The computer server system of claim 1, wherein the first resource type is provided from a first resource account and the second resource type is provided from a second resource account.

11. A computer-implemented method comprising:
monitoring resource consumption data to identify a first resource type being provided to a resource requester at a periodic rate;
identifying a second resource type to replace or offset the first resource type at the periodic rate; and
performing operations to automatically provide the second resource type to replace or offset the first resource type at the periodic rate.

12. The computer-implemented method of claim 11, further comprising:
determining an amount of the first resource type provided to the resource requester at the periodic rate; and
providing an amount of the second resource type to replace or offset the first resource type at the periodic rate based on the amount of the first resource type provided to the resource requester at the periodic rate.

13. The computer-implemented method of claim 12, wherein the amount of the second resource type provided to replace or offset the first resource type at the periodic rate is determined based on a modifier between the first resource type and the second resource type.

14. The computer-implemented method of claim 11, wherein the second resource type is provided to replace the first resource type at the periodic rate and the method further comprises:
automatically providing the second resource type to the resource requester to replace the first resource type at the periodic rate.

15. The computer-implemented method of claim 11, wherein the second resource type is provided to offset the first resource type at the periodic rate and the method further comprises:
automatically providing the second resource type to a resource account associated with the first resource type at the periodic rate to offset the first resource type.

16. The computer-implemented method of claim 11, further comprising:
obtaining, via a communications module, usage data;
analyzing the usage data to determine that a service provided by the resource requester is not being used; and
responsive to determining that the service provided by the resource requester is not being used, sending, via the communications module and to a computing device, a signal causing the computing device to display a user interface that includes a recommendation for cancelling the service provided by the resource requester and a selectable interface element for accepting the recommendation.

17. The computer-implemented method of claim 16, further comprising:
receiving, via the communications module and from the computing device, a signal indicating selection of the selectable interface element for accepting the recommendation; and
sending, via the communications module and to a third party server associated with the resource requester, a signal requesting cancellation of the service provided by the resource requester.

18. The computer-implemented method of claim 16, wherein the usage data includes at least one of network data obtained from a third party server associated with the resource requester or location data obtained from the computing device.

19. The computer-implemented method of claim 11, further comprising:
sending, via a communications module and to a computing device, a signal causing the computing device to display a user interface that includes a recommendation for providing the second resource type to replace or offset the first resource type at the periodic rate and a selectable interface element for accepting the recommendation; and
receiving, via the communications module and from the computing device, a signal indicating selection of the selectable interface element for accepting the recommendation.

20. A non-transitory computer readable storage medium comprising computer-executable instructions which, when executed, configure a processor to:
monitor resource consumption data to identify a first resource type being provided to a resource requester at a periodic rate;
identify a second resource type to replace or offset the first resource type at the periodic rate; and
perform operations to automatically provide the second resource type to replace or offset the first resource type at the periodic rate.
